(19) United States
(12) Patent Application Publication
(10) Pub. No.: US 2015/0324827 A1
(43) Pub. Date: Nov. 12, 2015

(54) System and Method for Advertisement Feedback, Incentives, Rewards and Social Discovery of Advertisements

(71) Applicant: LoopMe Ltd., London (GB)

(72) Inventors: Stephen UPSTONE, London (GB); Marco VAN DE BERGH, Susteren (NL)

(21) Appl. No.: 14/409,709

(22) PCT Filed: Jun. 20, 2013
(86) PCT No.: PCT/IB2013/001297

§ 371 Date: Dec. 19, 2014

Related U.S. Application Data
(60) Provisional application No. 61/662,262, filed on Jun. 20, 2012.

(51) Int. Cl. G06Q 30/02; G06F 17/30

(52) U.S. Cl. CPC G06Q 30/0217; G06F 17/30876; G06Q 30/0241

(57) ABSTRACT

A system for providing advertising content feedback, incentives and rewards and methods for making and using same. Embodiments include providing a personalized presentation of advertising content, providing the ability to receive feedback regarding advertising content, sharing advertising content with friends, and receiving incentives and/or rewards for providing feedback, sharing content, or having friends purchase goods or services related to advertising content.

### CROSS-REFERENCE TO RELATED APPLICATIONS

This application claims the benefit of U.S. Provisional Application No. 61/662,262, filed Jun. 20, 2012, which application is hereby incorporated herein by reference in its entirety.

### FIELD

The present disclosure relates generally to advertising and more particularly, but not exclusively, to systems and methods for advertisement feedback, incentives, rewards, and social discovery of advertisements.

### BACKGROUND

Consumers are inundated with various types of advertising content on television, mobile devices, and while accessing the internet, but typically lack the ability to actively control and interact with such advertising content. For example, consumers are conventionally served with advertising content, regardless of whether the user would have an interest in the content. Accordingly, a large majority of advertising is wasted on viewers who have no interest in the goods or services being advertised, or would not be eligible buyers for such goods and services.

Additionally, consumers lack the ability to provide feedback about advertising content or about the goods or services being advertised. Unfortunately, advertisers are therefore unable to determine which advertising campaigns are more successfully engaging consumers, and are unable to provide personalized and more relevant advertising content to consumers. Moreover, advertisers are unable to reward consumers for providing valuable feedback regarding advertising content.

Many consumers also desire to share advertising content with friends because they may enjoy the content, or because they may like the products or services being advertised. Conventional advertising can be difficult to share among friends, and there is no way to track, incentivize and reward consumers who share advertising with their friends. Additionally, there is no way to provide sharing consumers with further rewards and incentives for having friends purchase goods or services associated with advertising content or for sharing consumers to leverage the buying power of a group of users to receive rewards and incentives.

Conventional advertising also fails to allow consumers to socially discover and search for advertising based on feedback of friends and other users, nor does conventional advertising provide for discovery of advertising that is promoted, disliked or shared by enthusiasts, experts, friends or celebrities.

In view of the foregoing, a need exists for improved systems and methods for advertisement feedback, incentives and rewards, in an effort to overcome the aforementioned obstacles and deficiencies of conventional user account registration systems.

### BRIEF DESCRIPTION OF THE DRAWINGS

FIG. 1 is an exemplary top-level block diagram illustrating an embodiment of a content feedback, incentive, and reward system.

FIG. 2 is an exemplary data flow diagram illustrating an embodiment of a data flow path between a user device, the list server and content server of FIG. 1, in which a content list is generated and presented.

FIG. 3 depicts a user interface presenting a content list in accordance with an embodiment.

FIG. 4 is an exemplary flow chart illustrating an embodiment of a method executed by the list server of FIG. 1, for generating and providing a content list.

FIG. 5 is an exemplary flow chart illustrating an embodiment of a method executed by the content server of FIG. 1, for generating a content list.

FIG. 6 is an exemplary data flow diagram illustrating an embodiment, in which content feedback is received and a feedback reward is generated.

FIG. 7a depicts a user interface presenting content in accordance with an embodiment.

FIG. 7b depicts a user interface for content feedback in accordance with an embodiment.

FIG. 7c depicts a user interface for sharing content in accordance with an embodiment.

FIG. 8 is an exemplary flow chart illustrating an embodiment of a method executed by the content server of FIG. 1, for content feedback.

FIG. 9 is an exemplary flow chart illustrating an embodiment of a method executed by a user device of FIG. 1, for content feedback.

FIG. 10 is an exemplary data flow diagram illustrating an embodiment of a data flow path between the first and second user device and the list server and content server of FIG. 1, in which a user reward is provided.

FIG. 11 is an exemplary data flow diagram illustrating an embodiment of a data flow path between a user device, the list server and content server of FIG. 1, in which a user reward is presented on the user device.

FIG. 12 is an exemplary flow chart illustrating an embodiment of a method executed by the content server of FIG. 1, for generating a user reward associated with a user profile.

FIG. 13 is an exemplary flow chart illustrating an embodiment of a method, executed by a user device of FIG. 1, for initiating a content action related to received shared content.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

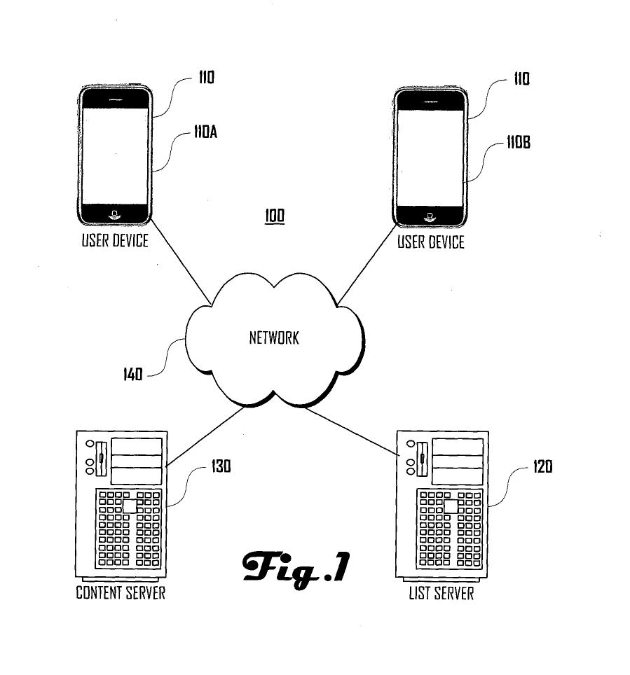

Since currently-available user account systems fail to effectively provide for advertising content feedback, incentives and rewards, a system that provides for such functionalities can prove desirable and provide'a basis for a wide range of applications, such as providing a personalized presentation of advertising content, providing the ability to easily provide feedback regarding advertising content, sharing advertising content with friends, and receiving incentives and/or rewards for providing feedback, sharing content, and having friends purchase goods or services related to advertising content, or the like. Such results can be achieved, according to one embodiment disclosed herein, by a system 100 as illustrated in FIG. 1.

Turning to FIG. 1, the system 100 is shown as including at least one user device 110. As an example, FIG. 1 depicts a first and second user device 110A, 110B, a list server 120 and a content server 130 that are operably connected via a network 140.

The user devices 110, servers 120, 130, and network 140 each can be provided as conventional communication devices of any type. For example, the user devices 110A, 110B may be smart-phones as depicted in FIG. 1; however, in various embodiments, the user devices 110A, 110B may be various suitable devices including a tablet computer, laptop computer, desktop computer, gaming device, or the like without limitation. The user devices 110 also may include uniform and/or different devices. In other words, two user devices may be smart phones, but a third device could be a laptop computer.

Additionally, the servers 120, 130 may be any suitable device, may comprise a plurality of devices, or may be a cloud-based data storage system. As discussed in further detail herein, servers 120, 130 may be operated by the same company or group, or may be operated by different companies or groups. In various embodiments, the network 140 may comprise one or more suitable wireless or wired networks, including the Internet, a local-area network (LAN), a wide-area network (WAN), or the like.

In various embodiments, there may be a plurality of any of the user devices 110, the list server 120, and/or the content server 130. For example, in an embodiment, there may be a plurality of users that are associated with one or more user devices 110, and the users (via user devices 110) and list server 120 may communicate with or interact with a plurality of content servers 130.

Although embodiments described herein include actions performed by the list server 120 or content server 130, in some embodiments any of these described actions may be performed by either of the list server 120 or content server 130. Additionally, in further embodiments, the list server 120 and content server 130 may be the same server.

As discussed in further detail herein, the user devices 110A, 110B, the list server 120, and the content server 130, can intercommunicate to achieve functionalities such as providing advertisement feedback, incentives, rewards, and the like.

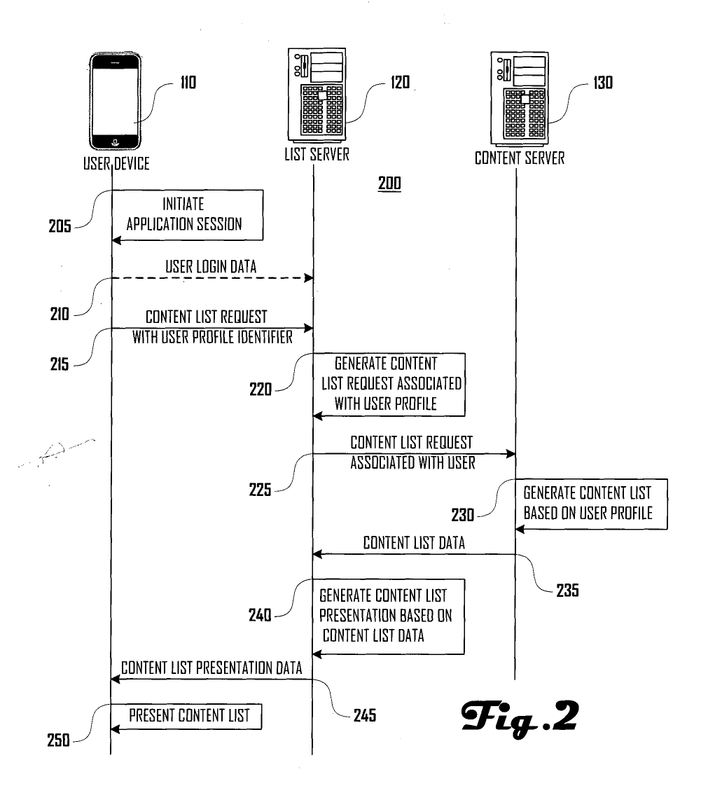

FIG. 2 is an exemplary data flow diagram illustrating an embodiment of a data flow path 200 between a user device 110, the list server 120 and content server 130 of FIG. 1, in which a content list is generated and presented. The data flow path 200 begins where the user device 110 initiates an application session at 205, and at 210, in an optional step, login data is sent to the list server 120.

For example, the user device 110 may store and execute various software applications, which may be configured to present a user interface as discussed herein and which may be operable to facilitate any of the communications or functionalities described herein. Some embodiments may allow or require a user to log in to a user account or the like, which may include inputting a user name, a password, or the like.

Returning to the data flow path 200, at 215, a content list request associated with a user profile is sent to the list server 120, where a content list request is generated at 220, which is associated with the user profile. The content list request associated with the user profile is sent to the content server 130, at 225, where a content list is generated based on the user profile.

For example, in an embodiment, a user may want to receive an updated list of content as further described herein, and the application running on the user device may request an updated content list from the list server 120. The list server 120 may then communicate with one or more content server 130 to obtain a portion of the content list.

A content server 130 may store a plurality of user profiles, which may allow for personalized content lists to be generated for each user profile. For example, as described herein, a user may provide feedback regarding content, which may include positive or negative feedback regarding advertising content, positive or negative feedback regarding goods or services associated with advertizing content, or the like.

Accordingly, in some embodiments, a content list may be generated based on user profile data. For example, user profile data may include content feedback, advertising content feedback, feedback related to goods and services; likes or dislikes of advertising content along with advertisement metadata (e.g., metadata indicating type of advertisement); user share actions, which may be related to advertisement metadata; user block actions, which may be related to advertisement metadata; and user save actions, which may related to advertisement metadata. Additionally, in some embodiments, a content list may be generated based on other user profile data which may include user biographical data, user location data, other user preference data, information in or related to other user accounts (e.g., Facebook, Twitter, LinkedIn), or the like.

User profile data or other data may be used to determine a user's propensity to interact with certain types of advertisements, types of advertisers, types of goods or services, or the like; may be used to determine a user preference of types of advertisements, types of advertisers, types of goods or services, or the like; may be used to determine a user's propensity to share types of advertisements, types of advertisers, types of goods or services, or the like; may be used to determine a user's propensity to endorse types of advertisements, types of advertisers, types of goods or services, or the like; may be used to determine a user's propensity to interact with certain types of advertisements, types of advertisers, types of goods or services, or the like based on endorsements or sharing from friends or other users.

In various embodiments, content may be selected based on user endorsement or “liking” of a given advertisement. For example, another user, which may include an associated “friend” user, unrelated user, enthusiast, expert or celebrity user, may endorse or “like” a given advertisement, and such advertisements may be selected as a portion of a content list.

Accordingly, various embodiments allow user profile data, or other data to be used to select and provide content tailored for each consumer that the consumer is more likely to have an affinity for in terms of the advertising vehicle, advertising content, goods and services advertised, persons or other entities associated with the advertising content, person or other entity that shared or endorsed the content, or the like.

In addition to receiving selected advertisements, a user may discover advertisements by searching for or browsing user profiles. For example, a user may view a user profile of an associated “friend” user, unrelated user, enthusiast, expert, celebrity user, or the like, and view a history of advertisements or other content that the user has liked, disliked, endorsed, or otherwise provided feedback on. Viewing such user profiles may be done via a user interface or software application described herein, or via a social network or other website in some embodiments.

Returning to the data flow path 200, content list data is sent to the list server 120 at 235 and a content list presentation is generated based on the content list data at 240. Content list presentation data is sent to the user device 110, at 245, and the user device 110 presents the content list, at 250.

In some embodiments, generating a content list presentation may include formatting content list data, selecting a content presentation order, removing one or more item from a content list. Generating a content list may also include adding or removing fields, metadata, or the like as discussed in further detail herein. In some embodiments, where content list data is received from a plurality of content servers 130, generating a content list may include combining, filtering, ordering, or otherwise formatting content list data received from a plurality of content servers 130.

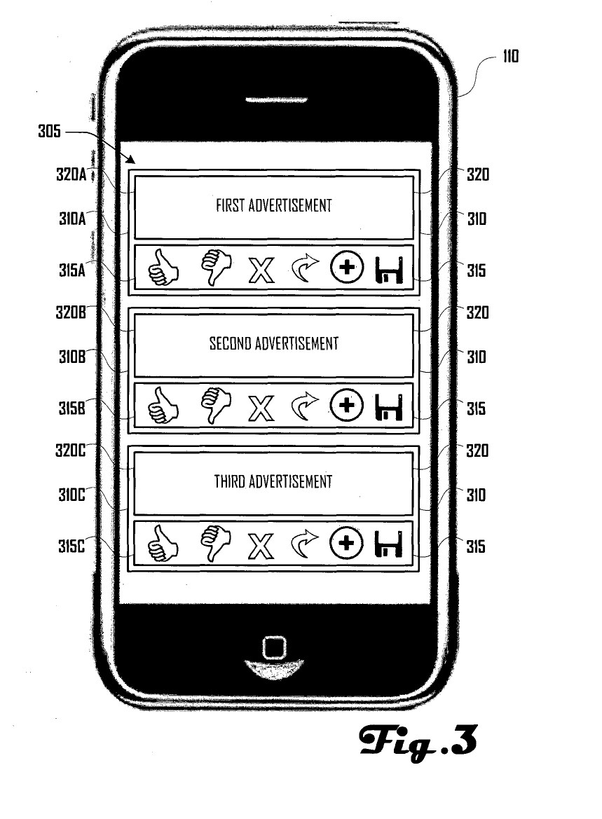

FIG. 3 depicts a user device 110 presenting a content list 305 in accordance with an embodiment. The content list includes a plurality of content items 310 (e.g., three content items 310A, 310B, 310C). Each content item includes an advertisement portion 320 (e.g., the three advertising portions 320A, 320B, 320C) and a content action portion 315 (e.g., the three content action portions 315A, 315B, 315C). The content action portion 315 may include one or more button that allows a user to provide positive or negative feedback about advertising portion 320; block an advertisement, company, or goods or services associated with an advertisement; discover similar advertisements, companies or goods or services associated with an advertisement; share an advertisement presented in the advertising portion 320; save an advertisement presented in the advertising portion 320; or the like.

The content action portion 315 may also present various suitable messages or data. For example, the content action portion may indicate a number of users that have provided positive feedback, negative feedback, saved content items, or the like. Additionally, the content action portion 315 may also indicate one or more user that has liked, endorsed, or provided positive feedback related to a given content item 310. For example, celebrity endorsements or “friend” user endorsements may be indicated.

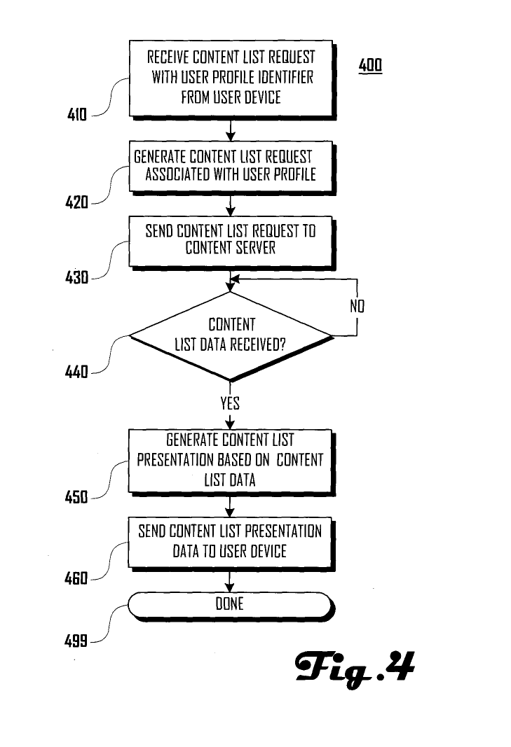

FIG. 4 is an exemplary flow chart illustrating an embodiment of a method 400 executed by the list server 120 of FIG. 1, for generating and providing a content list. The method 400 begins in block 410 where a content list request with a user profile identifier is received from a user device 110. In block 420, a content list request associated with the user profile is generated, and in block 430, the content list request is sent to the content server 130. In decision block 440, a determination is made whether content list data is received.

If content list data is not received, then the method 400 waits until content list data is received. However, if content list data is received, at 450, a content list presentation is generated based on the content list data, and at 460, the content list presentation data is sent to the user device 110. The method 400 is done in block 499.

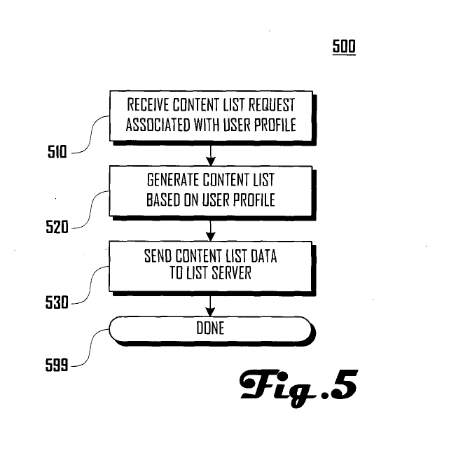

FIG. 5 is an exemplary flow chart illustrating an embodiment of a method 500 executed by the content server 130 of FIG. 1, for generating a content list. The method 500 begins in block 510 where a content list request associated with a user profile is received from the list server 120. In block 520, a content list is generated based on the user profile, and in block 530, content list data is sent to the list server 120. The method 500 is done in block 599.

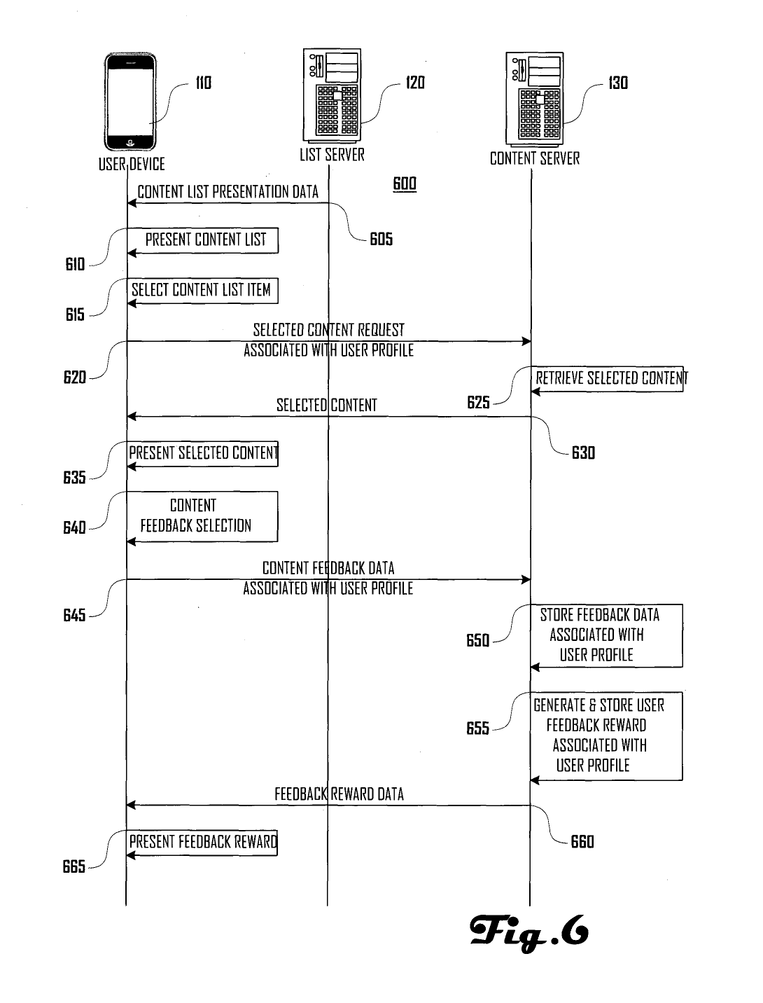

FIG. 6 is an exemplary data flow diagram illustrating an embodiment of a data flow path 600 between a user device 110, the list server 120 and content server 130 of FIG. 1, in which content feedback is received and a feedback reward is generated.

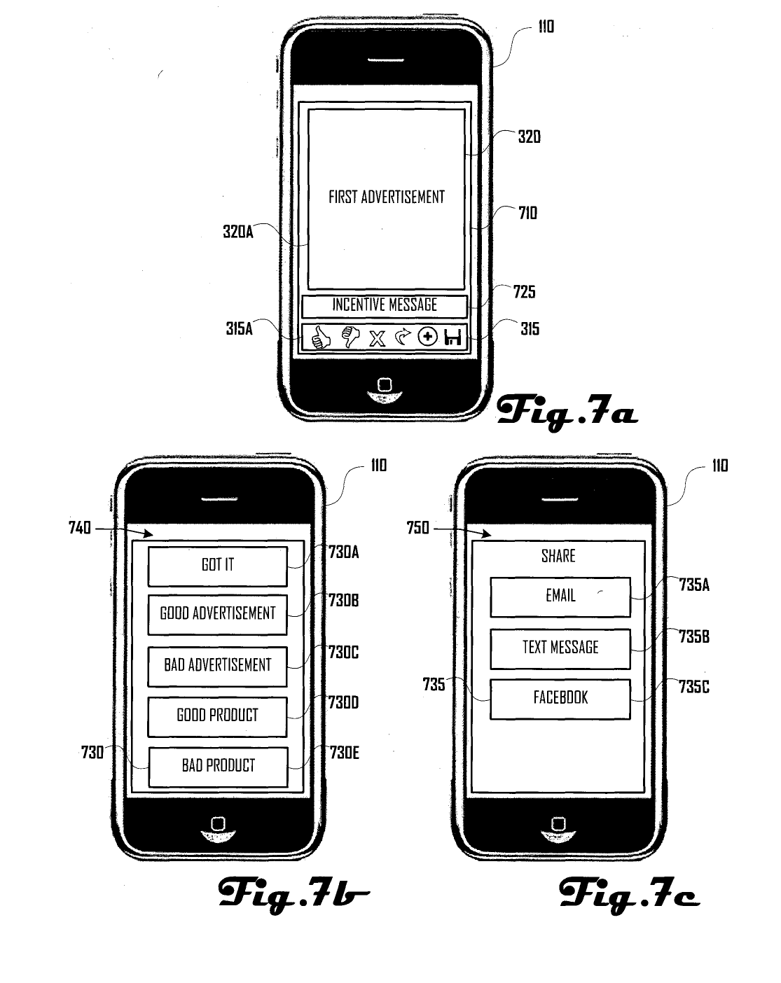

The data flow 600 begins at 605 where content list presentation data is sent to the user device 110, and at 610, the user device 110 presents the content list (e.g., as depicted in FIG. 3). At 615, a content list item 310 (FIG. 3) is selected, and at 620, a selected content request associated with a user profile is sent to the content server 130. At 625, the selected content is retrieved and sent to the user device 110, at 630, where the selected content is presented, at 635. For example, as depicted in FIG. 7a, selected content 710 may be presented, which includes an advertising portion 320, a content action portion 315, and an incentive action portion 725.

Returning to the data flow 600, a content feedback selection is made, and content feedback selection data associated with the user profile is sent to the content server 130, at 650. For example, referring to FIGS. 7a and 7b, a content feedback selection may include a feedback selection such as positive or negative feedback selected via the content action portion 315. In some embodiments, the incentive action portion 725 may display an incentive message such as “provide feedback to get a discount.” The user may click the incentive action portion 725, which may present a feedback menu 740, which allows for selection of one or more feedback items 730 (e.g., feedback items 730A-E). One or more feedback items may be selected to indicate that the user has purchased or owns the advertized good, or has received the advertised services (e.g., “GOT IT” feedback item 730A); to indicate positive or negative feedback about advertising content 320 (e.g., 730B, 730C); or provide positive or negative feedback about an advertized product or service (e.g., 730D, 730E). In some embodiments, feedback may also include positive or negative feedback regarding a company associated with advertising content 320; feedback regarding likelihood of purchasing an advertised good or service; feedback regarding an advertised price; or the like. In some embodiments, feedback may include a sliding scale, text input, yes/no questions, positive feedback, neutral feedback; negative feedback, a star rating, or the like.

Returning to the data flow path 600, feedback data is stored associated with the user profile, at 650, and a user feedback reward associated with the user profile is generated and stored at 655. Feedback reward data is sent to the user device 110, at 660, where the feedback reward is presented, at 665. For example, a user may select a feedback item 730 as shown in FIG. 7b, and the interface may then return to the selected content 710, and the incentive action portion 725 may indicate or present a feedback award (e.g., “you have received 5% off this advertisement”).

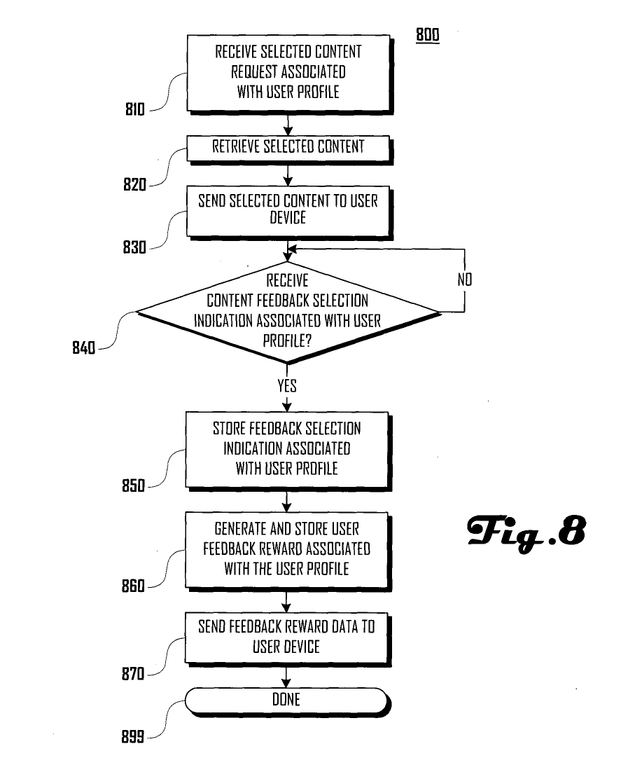

FIG. 8 is an exemplary flow chart illustrating an embodiment of a method 800 executed by the content server of FIG. 1, for content feedback. The method 800 begins in block 810, where a selected content request associated with a user profile is received, and at 820, selected content is retrieved. At 830, selected content is sent to a user device 110, and in decision block 840 a determination is made whether a content feedback selection indication associated with a user profile is received.

If a content feedback selection indication associated with a user profile is not received, the method 800 waits until a content feedback selection indication associated with a user profile is received. If a content feedback selection indication associated with a user profile is received, then in block 850, the received feedback selection indication is stored. At 860, a user feedback reward associated with the user profile is generated and stored, and at 870, user feedback reward data is sent to the user device 110.

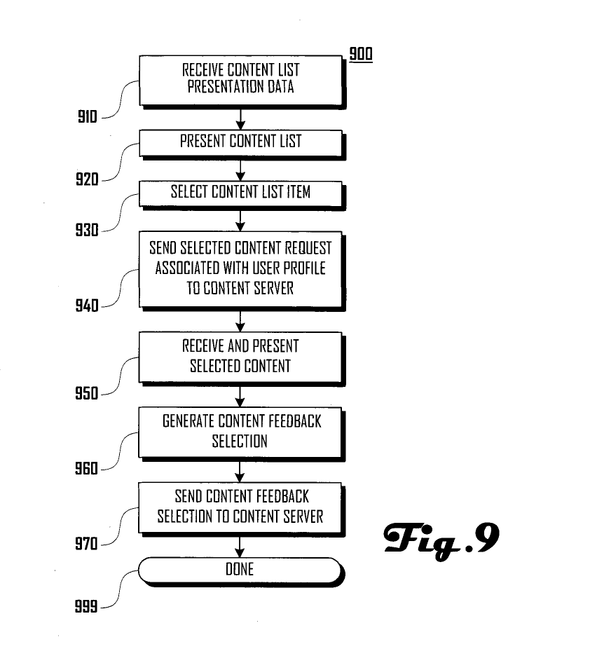

FIG. 9 is an exemplary flow chart illustrating an embodiment of a method 900 executed by a user device of FIG. 1, for content feedback. The method 900 begins in block 910, where content list presentation data is received, and in block 920, the content list is presented. In block 930, a content list item selection is made, and in block 940, a selected content request associated with the user profile is sent to the content server 130. In block 950, selected content is received and presented, and in block 960, a content feedback selection is generated. In block 970, a content feedback selection is sent to the content server 130, and the method 900 is done in block 999.

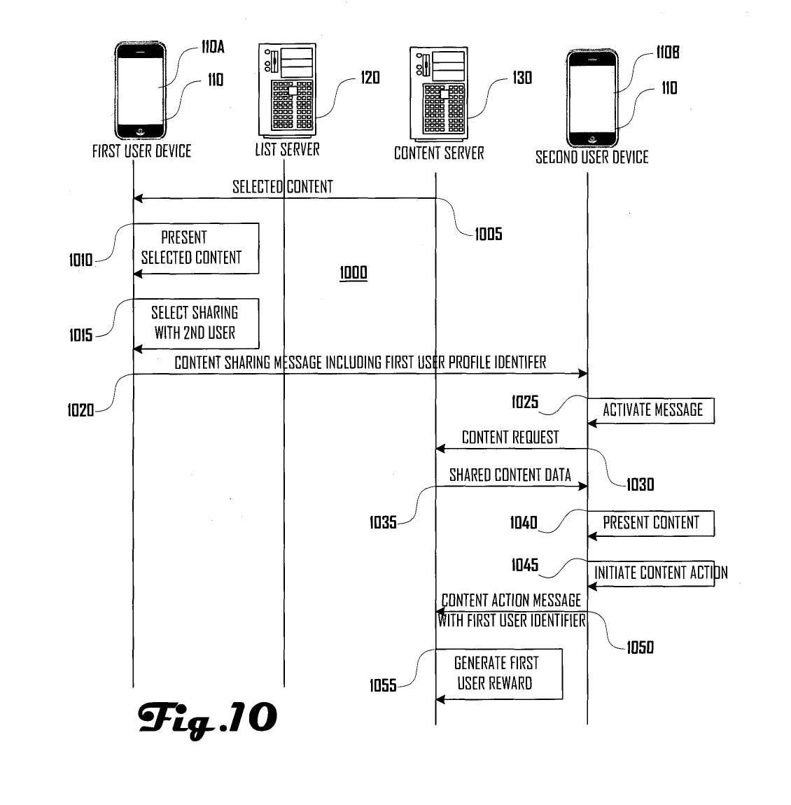

FIG. 10 is an exemplary data flow diagram illustrating an embodiment of a data flow path 1000 between the first and second user device 110A, 110B and the list server 120 and content server 130 of FIG. 1, in which a user reward is provided. The data flow path 1000 begins where selected content is sent to the first user device 110A, at 1005, and the selected content is presented, at 1010. For example, presentation of selected content may be as depicted in FIG. 7a.

At 1015, sharing with a second user is selected and a content sharing message is sent to the second user device 110B, at 1020. For example, a user may select sharing with a second user via the incentive action portion 725 or via the content action portion 315 as shown in FIG. 7a. In some embodiments, the incentive action portion 725 may provide a message indicating a sharing incentive, which may include a message such as “share this advertisement with a friend to receive a discount.” The user may click the incentive action portion 725 and be presented with a sharing menu 750 as depicted in FIG. 7c, which includes a plurality of sharing buttons 735, which may provide an option to share via email 735A, a text message 735B, a social network such as Facebook 735C, or the like.

Clicking a sharing button 735 may initiate communicating a sharing message. A sharing message may include a link to content, and may also include or be associated with a user profile or user profile identifier associated with the sending user. Although FIG. 10 depicts a content sharing message being provided directly to a second user device 110B, in various embodiments, one or more devices, servers, networks or the like may be used to send a sharing message to a second user device 110B. For example, sending an e-mail sharing message may include one or more e-mail server; sending a sharing message via a social network may include a social network server; sending a sharing message may involve the list server 120 or content server 130 in some embodiments; or the like. Accordingly, sending messages via conventional means is contemplated as part of the present disclosure.

Returning to the data flow path 1000 of FIG. 10, at 1025, the content sharing message is activated at the second user device 110B, and a content request is sent to the content server 130, at 1030. Shared content data is provided to the second user device 110B, at 1035 and at 1040, the shared content is presented at the second user device 110B.

In some embodiments, presenting the shared content may be via a user interface as depicted in FIG. 7a, and the second user device 110B may have a copy of a device application on the first user device 110A that facilitated sending the content sharing message. However, in some embodiments, content may be presented on the second user device 110B in any suitable way, including by clicking a link and presenting content in a web browser or the like.

Activation of the content sharing message, at 1025, may or may not include user interaction. For example the content sharing message may self activate and present content without user interaction. In other embodiments, a hyperlink, file, or the like may be received, which may be executed or clicked by a user to present or initiate presentation of the shared content.

Returning to the data flow path 1000, a content action is initiated, at 1045, and a content action message with a first user profile identifier is sent to the content server 130, at 1050. A first user reward is generated, at 1055, which is associated with the first user profile.

For example, in addition to possibly receiving a reward for sharing content or an advertisement with a friend, a sharing user may also receive a reward when the friend performs an action with the shared content. A content action may include buying a product or service, viewing media, visiting a website, viewing shared content, a social network action, or the like.

For purposes of tracking and ensuring that the appropriate user is provided with a reward, a user profile indicator may be included in content sharing messages and in features of shared content so that actions by the second user may be tracked in relation to the first sharing user. The first user may then be rewarded based on various behaviors of the second user, and may receive a greater reward for greater interaction or additional sharing of the content by the second user. For example, if the second user simply views the shared content, there may be less of a reward than if the second user purchases a good or service associated with an advertisement or if the second user shares the content with other users.

As discussed herein, rewards and incentives may include any suitable reward or incentive, and may include a monetary reward, free goods or services, discounted goods and services, a coupon, entry into a raffle, free or discounted tickets or admittance to a venue, virtual currency, points, an award, publicity, or the like.

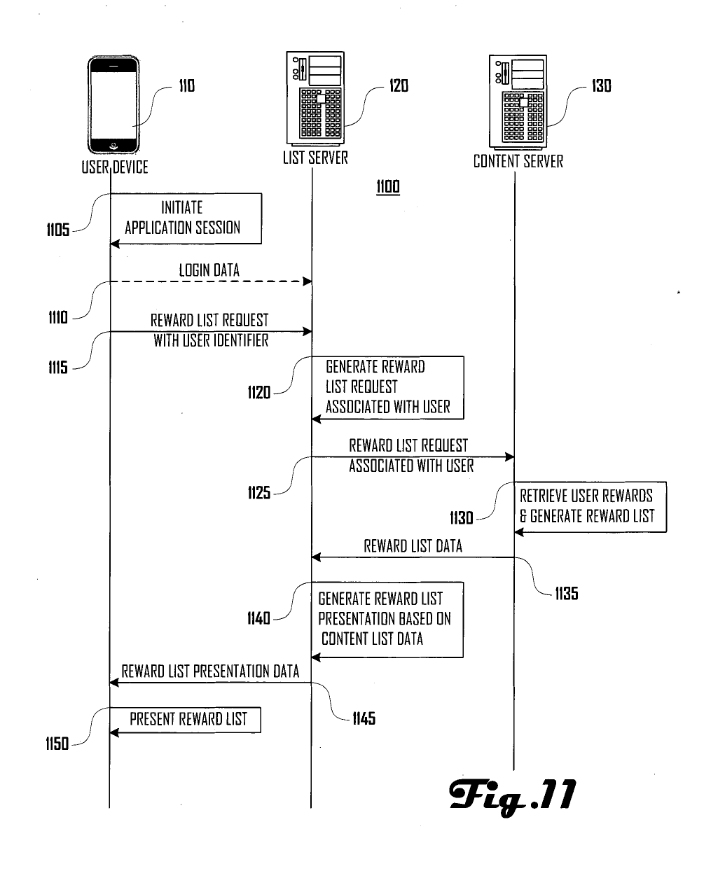

FIG. 11 is an exemplary data flow diagram illustrating an embodiment of a data flow path 1100 between a user device 110, the list server 120 and content server 130 of FIG. 1, in which a reward list is generated and presented. The data flow path 1100 begins where the user device 110 initiates an application session at 1105, and at 1110, in an optional step, login data is sent to the list server 120.

At 1115, a reward list request associated with a user profile is sent to the list server 120, where a reward list request is generated at 1120, which is associated with the user profile. The reward list request associated with the user profile is sent to the content server 130, at 1125, where a reward list is generated based on the user profile.

For example, in an embodiment, a user may want to receive an updated list of rewards received by the user, and the application running on the user device 110 may request an updated reward list from the list server 120. The list server 120 may then communicate with one or more content servers 130 to obtain a portion of the reward list. User reward data may also be stored on the list server 120 in some embodiments.

Reward list data is sent to the list server 120, at 1135, and a reward list presentation is generated based on the reward list data, at 1140. Reward list presentation data is sent to the user device 110, at 1145, and the user device 110 presents the reward list, at 1150.

Users may be informed of rewards that they have earned in other ways. For example, users may also receive an e-mail, text message, or the like, which informs the user of earned user rewards. Additionally, reward data may be presented via a content presentation (e.g., FIG. 7a-c). For example, an earned reward may be displayed in an incentive action portion 725, or other portion of a content presentation.

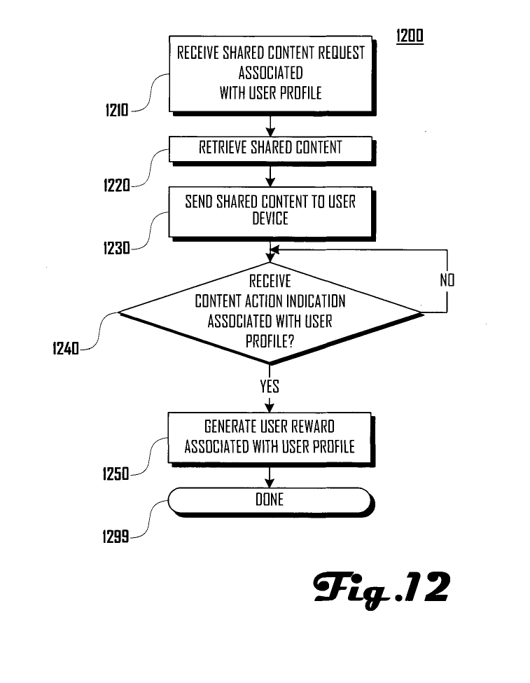

FIG. 12 is an exemplary flow chart illustrating an embodiment of a method 1200 executed by the content server of FIG. 1, for generating a user reward associated with a user profile. The method 1200 begins in block 1210 where a shared content request associated with a user profile is received, and in block 1220, the shared content is retrieved. In block 1230, the shared content is sent to a user device 110, and in decision block 1240, a determination is made whether a content action indication associated with the user profile is received, and if not, the method 1200 waits until a content action indication associated with the user profile is received.

However, if a content action indication associated with the user profile is received, then in block 1250, a user reward associated with the user profile is generated, and the method 1200 is done in block 1299.

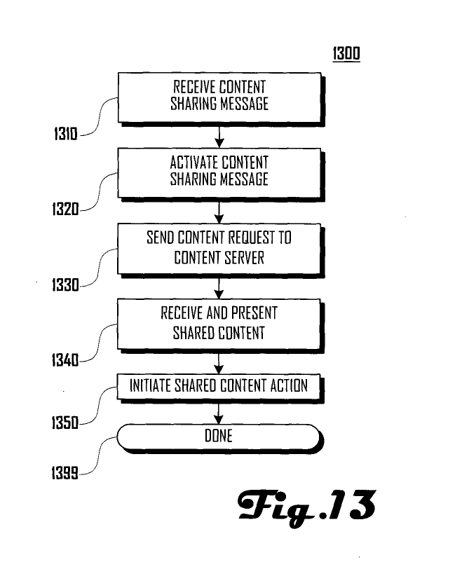

FIG. 13 is an exemplary flow chart illustrating an embodiment of a method 1300, executed by a user device of FIG. 1, for initiating a content action related to received shared content. The method 1300 begins in block 1310, where a content sharing message is received, and in block 1320, the content sharing message is activated. In block 1330, a content request is sent to the content server 130, and in block 1340, shared content is received and presented. In block 1350, a shared content action is initiated, and the method 1300 is done in block 1399.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for advertisement feedback and reward comprising:
receiving a selected content request associated with a user profile from a user device;
providing the selected content to the user device, the selected content comprising an advertisement portion and a feedback portion;
receiving advertisement feedback data associated with the selected content and the user profile; and
generating a feedback reward associated with the selected content and the user profile.

2. The method of claim 1, further comprising providing feedback reward data to the user device.

3. The method of claim 1, further comprising:
receiving a content list request associated with the user profile from the user device; and
generating a content list based on the user profile, the content list comprising the selected content.

4. The method of claim 1, further comprising:
receiving a content list request associated with the user profile;
generating a second content list request associated with the user profile;
sending the second content list request to a content server;
receiving content list data from the content server; and
generating a content list presentation based on the received content list data, the content list comprising the selected content.

5. The method of claim 1, wherein the feedback reward comprises a discount.

6. The method of claim 5, wherein the discount is a discount related to goods or services associated with the advertisement portion.

7. The method of claim 1, wherein the advertisement feedback data comprises one of a positive or negative feedback indication related to the advertising portion.

8. The method of claim 1, wherein the advertisement feedback data comprises one of a positive or negative feedback indication related to goods or services advertised in the advertising portion.

9. A method of providing a user reward comprising:
receiving a content request from a user device, the content request associated with a first user profile, and a first user content sharing message;
providing the requested content to the user device, the requested content comprising an advertising portion and a content action portion;
receiving a content action message associated with the content action portion; and
generating a user reward associated with the first user profile.

10. The method of claim 9, wherein the content action message comprises an indication that a user associated with the content sharing message purchased at least one good or service associated with the advertising portion.

11. The method of claim 9, wherein the user reward comprises a discount.

12. The method of claim 11, wherein the discount is associated with at least one good or service associated with the advertising portion.

13. The method of claim 9 wherein the content action portion is operable to facilitate a purchase of at least one good or service associated with the advertising portion.

14. The method of claim 9 further comprising providing reward list presentation data to a second user device associated with the first user profile.

15. The method of claim 9, further comprising providing reward list data to a list server.

16. The method of claim 9 further comprising generating reward list data comprising an indication of the user reward associated with the first user profile.
